(19) United States
(12) Patent Application Publication
(10) Pub. No.: US 2025/0223868 A1
(43) Pub. Date: Jul. 10, 2025

(54) MULTI-DIRECTIONAL STRETCHING CURTAIN

(71) Applicant: Tiancheng Pan, Cixi City (CN)

(72) Inventor: Tiancheng Pan, Cixi City (CN)

(21) Appl. No.: 19/090,128

(22) Filed: Mar. 25, 2025

(30) Foreign Application Priority Data
Oct. 24, 2024 (CN) 202422579814.7

(51) Int. Cl. E06B 9/24

(52) U.S. Cl. CPC E06B 9/24

(57) ABSTRACT

The present invention discloses a multi-directional stretching curtain which includes a box body, where a first curtain body and a second curtain body are provided in the box body; the first curtain body includes a first rotating shaft and a first curtain; the second curtain body includes a second rotating shaft and a second curtain, and the first curtain and the second curtain are pulled out in different directions, and at least partially overlap or are connected to form a complete background at least from a certain visual angle.

### TECHNICAL FIELD

The present invention belongs to the technical field of photographic and videographic accessories, and in particular relates to a multi-directional stretching curtain.

### BACKGROUND

With the progress of society and the improvement of people's living standards, people's requirements for quality of life are gradually increasing. As film, television and multimedia are gradually mature and stable, with the continuous innovation of mobile phone photography and the continuous improvement of people's requirements for image quality, image processing and video production have gradually become popular and are available for the general public. Image and video processing and production require a large amount of keying technology, so the premise of keying technology is to use a green background when shooting. However, in the past, the use of green background was mostly achieved by hanging a simple green cloth on the wall, which was not easy to carry and install, so it had certain limitations in use. At present, only one vertical surface of the retractable, integrated and foldable curtains on the market can be retracted in the shell, so objects on the ground cannot be completely covered by the curtain background during use. Since the curtain can be stretched only in one direction in the prior art, such curtain can only provide the scene of the back cloth and cannot provide the background of the ground because part of the objects will be located outside the curtain. Therefore, it is very important to urgently obtain a multi-directional stretching curtain that overcomes the above defects.

### SUMMARY

In order to solve at least one of the above technical problems, the present invention provides a multi-directional stretching curtain which includes a box body, where at least one first curtain body and at least one second curtain body are provided in the box body; the first curtain body includes a first rotating shaft and at least one first curtain wound on the first rotating shaft; and the second curtain body includes a second rotating shaft and at least one second curtain wound on the second rotating shaft, and the first curtain and the second curtain are pulled out in different directions, and at least partially overlap or are connected to form a complete background at least from a certain visual angle.

As a preferred embodiment of the above technical solution, the box body is provided with an opening, preferably one opening is provided, both the first curtain and the second curtain are pulled out from the opening, and the first curtain and the second curtain are stretched outward from the opening; both ends of the first rotating shaft are matched with an inner wall of the box body so that the first rotating shaft is at least partially rotatable; and both ends of the second rotating shaft are matched with the inner wall of the box body so that the second rotating shaft is at least partially rotatable.

With the technical solution described above, since only one opening is provided, and both curtains are pulled out from the opening, there is no visual field blocking between the curtains.

As a preferred embodiment of the above technical solution, the first curtain is drawn out to form a floor cloth extending in a first direction, and the second curtain is drawn out to form a back cloth extending in a second direction.

As a preferred embodiment of the above technical solution, a second support rod is provided at an end portion of the second curtain, and a telescopic assembly is provided between the second support rod and the box body.

Here, the telescopic assembly includes a first hinge and a second hinge that are cross-hinged to each other, and a third hinge, a fourth hinge, a fifth hinge and a sixth hinge; a first end of the third hinge is hinged to a first end of the first hinge, and a second end of the third hinge is hinged to the second support rod; a first end of the fourth hinge is hinged to a first end of the second hinge, and a second end of the fourth hinge is hinged to the second support rod; and a first end of the fifth hinge is hinged to a second end of the first hinge, and a second end of the fifth hinge is hinged to the box body; and a first end of the sixth hinge is hinged to a second end of the second hinge, and a second end of the sixth hinge is hinged to the box body.

Here, a first telescopic rod is hinged between the first hinge and the fifth hinge, and a second telescopic rod is hinged between the second hinge and the sixth hinge.

Preferably, an axis of the second rotating shaft is lower than an axis of the first rotating shaft in order to increase the visual angle of completely presenting the background.

Here, a first support rod is provided at an end portion of the first curtain to pull out the first curtain flat.

As a preferred embodiment of the above technical solution, at least one roller is provided in the box body, and at least part of the roller penetrates from an outer wall of the box body to the outside; and at least one perforation is provided on the box body, opposite bracket members are mounted in the box body, a rotating shaft is provided between the two bracket members, and a roller is provided on the rotating shaft.

A lifting handle is provided on the box body. The lifting handle is hinged to the box body.

The roller is at least partially exposed from a side wall of the box body, and the roller at least partially penetrates from a bottom portion of the box body. It is aimed to increase the smoothness of pulling the box body horizontally and obliquely.

The multi-directional stretching curtain further includes a cover body matched with the box body, at least one step groove is provided on the cover body, and a step protrusion matched with the step groove is provided on the box body.

With the technical solution described above, a lock catch is further provided between the cover body and the box body.

Compared with the prior art, the present invention has the advantages that the present invention has a simple structure, and the two-way telescopic, integrated and foldable curtain covering the floor solves the problem that the floor portion at the bottom of the objects being photographed cannot be covered as a background.

### BRIEF DESCRIPTION OF THE DRAWINGS

FIG. 1 is a first perspective view of the present invention;

FIG. 2 is a second perspective view of the present invention;

FIG. 3 is a perspective view of a hidden box body;

FIG. 4 is a schematic structural diagram of a box body and a cover body;

FIG. 5 is a schematic cross-sectional view of the present invention;

FIG. 6 is a schematic cross-sectional view of the present invention with a first curtain not drawn out; and

FIG. 7 is a schematic structural diagram of the present invention with the cover body mounted.

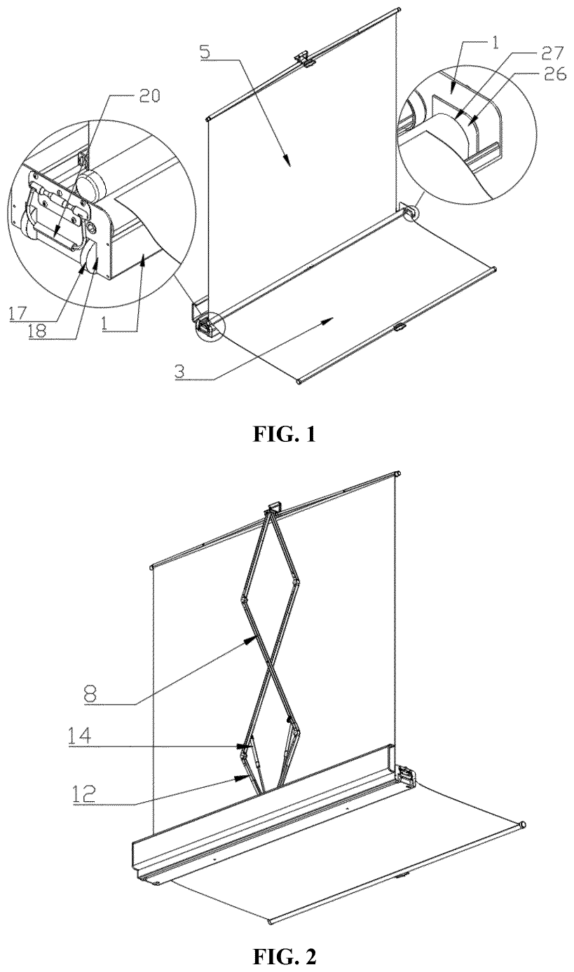

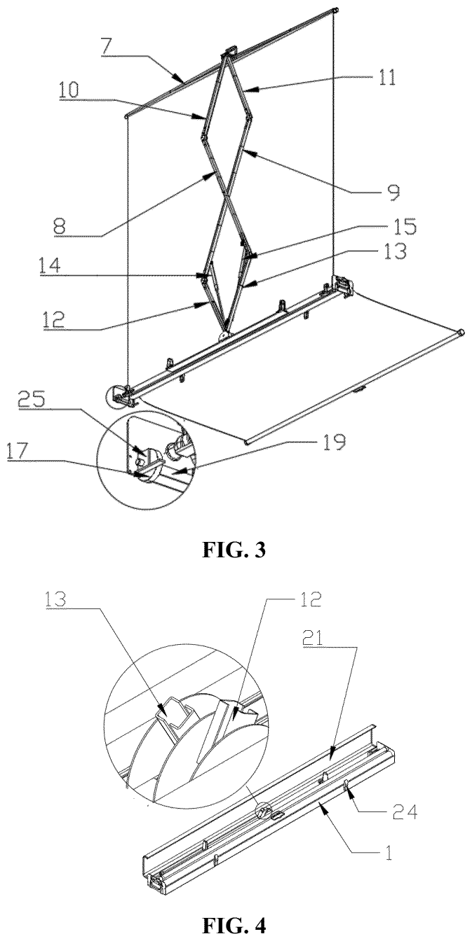

Description of reference numerals: 1. box body; 2. first rotating shaft; 3. first curtain; 4. second rotating shaft; 5. second curtain; 6. opening 7. second support rod; 8. first hinge; 9. second hinge; 10. third hinge; 11. fourth hinge; 12. fifth hinge; 13. sixth hinge; 14. first telescopic rod; 15. second telescopic rod; 16. first support rod; 17. roller; 18. perforation; 19. rotating shaft, 20. lifting handle; 21. cover body; 22. step groove; 23. step protrusion; 24. lock catch; 25. Bracket member; 26. Mount; and 27. rotating groove.

### DESCRIPTION OF THE EMBODIMENTS

In order to make those skilled in the art better understand the present invention and thereby define the scope of the present invention more clearly, the present invention is described below in detail with respect to some specific embodiments of the present invention. It should be noted that the following description only relates to some specific embodiments of the inventive concept and are only part of the embodiments of the present invention, specific and direct descriptions of relevant structures are merely for the convenience of understanding the present invention, and the specific features do not, of course, directly limit the implementation scope of the present invention.

Referring to the drawings, the present invention provides a multi-directional stretching curtain which includes a box body 1, and at least one first curtain body and at least one second curtain body are provided in the box body 1.

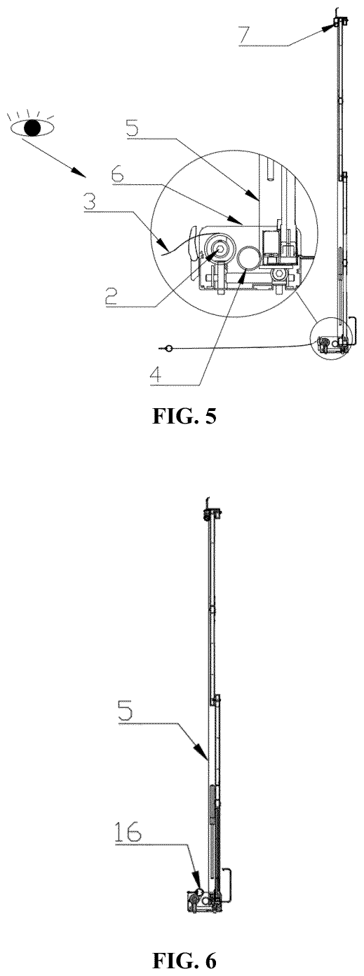

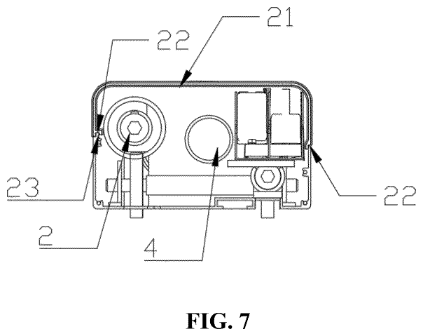

The first curtain body includes a first rotating shaft 2 and at least one first curtain 3 wound on the first rotating shaft 2; and the second curtain body includes a second rotating shaft 4 and at least one second curtain 5 wound on the second rotating shaft 4, and the first curtain 3 and the second curtain 5 are pulled out in different directions. At least from a certain visual angle, as shown in FIG. 5, when viewed from the direction of the eye arrow, the first curtain 3 and the second curtain 5 at least partially overlap or are connected to form a complete background.

As shown in FIG. 8, during use, when the first curtain 3 and the second curtain 5 are pulled out, and considering the winding thickness of the first curtain body and the second curtain body, the first rotating shaft 2 and the second rotating shaft 4 are close to each other or partially misaligned up and down, so that the first curtain 3 and the second curtain 5 that are unfolded at two places are visually connected.

For example, a plurality of rotating grooves 27 are provided on an inner wall of the box body 1, and both ends of the first rotating shaft 2 and both ends of the second rotating shaft 4 are arranged on the rotating grooves 27, or a plurality of mounts 26 are mounted on the inner wall of the box body 1, and a plurality of rotating grooves 27 are provided on the mounts 26.

As a preferred embodiment of the above technical solution, the box body 1 is provided with an opening 6, preferably one opening 6 is provided, both the first curtain 3 and the second curtain 5 are pulled out from the opening 6, and the first curtain 3 and the second curtain 5 are stretched outward from the opening 6; both ends of the first rotating shaft 2 are matched with the inner wall of the box body 1 so that the first rotating shaft 2 is at least partially rotatable; and both ends of the second rotating shaft 4 are matched with the inner wall of the box body 1 so that the second rotating shaft 4 is at least partially rotatable.

In other embodiments, if the box body 1 is made of a transparent material, two openings 6 can be provided, and the first curtain 3 and the second curtain 5 can be pulled out respectively.

In the present embodiment, the box body 1 is made of an opaque material, and then one opening 6 is provided, which does not block the first curtain 3 and the second curtain 5 from forming a complete background.

With the technical solution described above, since only one opening 6 is provided, and both the first curtain 3 and the second curtain 5 are pulled out from the opening 6, there is no visual field blocking between the curtains.

As a preferred embodiment of the above technical solution, the first curtain 3 is drawn out to form a floor cloth extending in a first direction, and the second curtain 5 is drawn out to form a back cloth extending in a second direction.

The first direction is a horizontal direction relative to the ground, and the second direction is a vertical direction relative to the ground.

As a preferred embodiment of the above technical solution, a second support rod 7 is provided at an end portion of the second curtain 5, and a telescopic assembly is provided between the second support rod 7 and the box body 1.

Here, the telescopic assembly includes a first hinge 8 and a second hinge 9 that are cross-hinged to each other, and a third hinge 10, a fourth hinge 11, a fifth hinge 12 and a sixth hinge 13.

A first end of the third hinge 10 is hinged to a first end of the first hinge 8, and a second end of the third hinge 10 is hinged to the second support rod 7.

A first end of the fourth hinge 11 is hinged to a first end of the second hinge 9, and a second end of the fourth hinge 11 is hinged to the second support rod 7.

A first end of the fifth hinge 12 is hinged to a second end of the first hinge 8, and a second end of the fifth hinge 12 is hinged to the box body 1; and a first end of the sixth hinge 13 is hinged to a second end of the second hinge 9, and a second end of the sixth hinge 13 is hinged to the box body 1.

Here, a first telescopic rod 14 is hinged between the first hinge 8 and the fifth hinge 12, and a second telescopic rod 15 is hinged between the second hinge 9 and the sixth hinge 13.

Preferably, an axis of the second rotating shaft 4 is lower than an axis of the first rotating shaft 2 in order to increase the visual angle of completely presenting the background.

Here, a first support rod 16 is provided at an end portion of the first curtain 3 to pull out the first curtain 3 flat.

As a preferred embodiment of the above technical solution, at least one roller 17 is provided in the box body 1, and at least part of the roller 17 penetrates from an outer wall of the box body 1 to the outside; and at least one perforation 18 is provided on the box body 1, opposite bracket members 25 are mounted in the box body 1, a rotating shaft 19 is provided between the two bracket members 25, and a roller 17 is provided on the rotating shaft 19. The two opposite bracket members 25 are mounted on both sides of the box body 1.

The box body 1 is provided with a lifting handle 20. The lifting handle 20 is hinged to the box body 1.

The roller 17 is at least partially exposed from a side wall of the box body 1, and the roller 17 at least partially penetrates from a bottom portion of the box body 1. It is aimed to increase the smoothness of pulling the box body 1 horizontally and obliquely.

The multi-directional stretching curtain further includes a cover body 21 matched with the box body 1, at least one step groove 22 is provided on the cover body 21, and a step protrusion 23 matched with the step groove 22 is provided on the box body 1.

With the technical solution described above, a lock catch 24 is further provided between the cover body 21 and the box body 1.

Compared with the prior art, the present invention has the advantages that the present invention has a simple structure, and the two-way telescopic, integrated and foldable curtain covering the floor solves the problem that the floor portion at the bottom of the objects being photographed cannot be covered as a background.

What is claimed is:

1. A multi-directional stretching curtain, comprising a box body, wherein at least one first curtain body and at least one second curtain body are provided in the box body;
the first curtain body comprises a first rotating shaft and at least one first curtain wound on the first rotating shaft; and the second curtain body comprises a second rotating shaft and at least one second curtain wound on the second rotating shaft, and the first curtain and the second curtain are pulled out in different directions, and at least partially overlap or are connected to form a complete background at least from a certain visual angle.

2. The multi-directional stretching curtain according to claim 1, wherein the box body is provided with an opening, and the first curtain and the second curtain are stretched outward from the opening.

3. The multi-directional stretching curtain according to claim 1, wherein both ends of the first rotating shaft are matched with an inner wall of the box body so that the first rotating shaft is at least partially rotatable; and both ends of the second rotating shaft are matched with the inner wall of the box body so that the second rotating shaft is at least partially rotatable.

4. The multi-directional stretching curtain according to claim 1, wherein the first curtain is drawn out to form a floor cloth extending in a first direction, and the second curtain is drawn out to form a back cloth extending in a second direction.

5. The multi-directional stretching curtain according to claim 1, wherein a second support rod is provided at an end portion of the second curtain, and a telescopic assembly is provided between the second support rod and the box body.

6. The multi-directional stretching curtain according to claim 5, wherein the telescopic assembly comprises a first hinge and a second hinge that are cross-hinged to each other, and a third hinge, a fourth hinge, a fifth hinge and a sixth hinge;
a first end of the third hinge is hinged to a first end of the first hinge, and a second end of the third hinge is hinged to the second support rod;
a first end of the fourth hinge is hinged to a first end of the second hinge, and a second end of the fourth hinge is hinged to the second support rod; and
a first end of the fifth hinge is hinged to a second end of the first hinge, and a second end of the fifth hinge is hinged to the box body; and a first end of the sixth hinge is hinged to a second end of the second hinge, and a second end of the sixth hinge is hinged to the box body.

7. The multi-directional stretching curtain according to claim 4, wherein an axis of the second rotating shaft is lower than an axis of the first rotating shaft.

8. The multi-directional stretching curtain according to claim 1, wherein a first support rod is provided at an end portion of the first curtain.

9. The multi-directional stretching curtain according to claim 1, wherein at least one roller is provided in the box body, and at least part of the roller penetrates from an outer wall of the box body to the outside.

10. The multi-directional stretching curtain according to claim 1, wherein a lifting handle is provided on the box body.

11. The multi-directional stretching curtain according to claim 9, wherein the roller is at least partially exposed from a side wall of the box body, and the roller at least partially penetrates from a bottom portion of the box body.

12. The multi-directional stretching curtain according to claim 1, wherein the multi-directional stretching curtain further comprises a cover body matched with the box body, at least one step groove is provided on the cover body, and a step protrusion matched with the step groove is provided on the box body.
